(19) United States
(12) Patent Application Publication
(10) Pub. No.: US 2006/0033482 A1
(43) Pub. Date: Feb. 16, 2006

(54) Supply of several loads by A D.C./D.C. converter

(75) Inventors: Arnaud Florence, Saint Antoine du Rocher (FR); Jerome Heurtier, Tours (FR)

Correspondence Address: SEED INTELLECTUAL PROPERTY LAW GROUP PLLC, 701 FIFTH AVE, SUITE 6300, SEATTLE, WA, 98104-7092, US

(73) Assignee: STMicroelectronics S.A., Montrouge (FR)

(21) Appl. No.: 11/197,121

(22) Filed: Aug. 4, 2005

(30) Foreign Application Priority Data
Aug. 6, 2004 (FR) 04/51801

(51) Int. Cl. G05F 1/577

(52) U.S. Cl. 323/267

(57) ABSTRACT

A power converter is shared between plural independent loads, by assigning to each of the loads periodic supply time windows during which the power converter is respectively dedicated thereto, the periodicity of the time windows being selected according to the remanence time of the loads.

### BACKGROUND OF THE INVENTION

1. Field of the Invention

The present invention relates to the field of power converters and, more specifically, D.C./D.C. converters of switched-mode power supply type. The present invention applies to step-up or step-down converters intended to supply several loads independent from one another.

The loads supplied by the power converter may be of different natures. An example of application relates to backlit screens of the type used in portable phones or personal digital assistants (PDA). Several series-associated light-emitting diodes (generally white diodes) form the different loads. According to the desired backlighting intensity, one or the others of the loads is supplied. Another example of application relates to a power dimming function performed by a halfwave between supplied branches.

2. Description of the Related Art

FIG. 1 shows a first conventional example of a D.C./D.C. converter for supplying several loads independent from one another.

It shows a voltage step-up converter intended to provide, between an output terminal 1 and ground 2, a voltage Vout higher than a D.C. input voltage Vdc applied between an input terminal 3 and ground 2. In a step-up converter, terminals 3 and 1 are connected to each other by an inductive element L in series with a diode D, the cathode of diode D being connected to terminal 1. The output voltage is sampled across a capacitor C connecting terminal 1 to ground. A cut-off switch M is connected between junction point 4 of inductance L and of diode D and the ground. Switch M is controlled by a circuit 5 (for example, PWM CTRL) in charge of supplying pulses for turning on switch M according to a reference value (OR) and to a control signal FB. Block 5 also receives a clock signal f_{M} enabling it to generate the control pulses of switch M. The control performed by circuit 5 on the control pulses may be of pulse-width modulation type (PWM), of frequency-width modulation type (FWM), etc.

The power converter is intended to supply several independent loads. In the example shown in FIG. 1, two loads 11 (Q1) and 12 (Q2) are connected to terminal 1. Each of the loads is in series with a switch, respectively K1, K2, controlled by a signal A1, A2 to select the load 11 or 12 which is to be supplied with voltage Vout. A resistor R1 or R2, respectively, connects the switch of each of the loads to ground 2.

In a power converter such as illustrated in FIG. 1, the regulation of voltage Vout is only performed on one of the loads. In this example, signal FB is sampled at point 6 between load 11 and resistor R1 which is used as a current-to-voltage converter to control voltage Vout according to reference voltage OR. For the regulation to be properly performed, resistors R1 and R2 must compensate for the impedance differences between the supplied loads 11 and 12. Such ballast resistors increase system losses.

FIG. 2 shows a second conventional example of a power converter intended to supply several loads. As compared with the assembly of FIG. 1, the only difference is the assembly of loads 11 and 12. In this example, two loads 11 and 12 are in series with a resistor R between terminal 1 and ground 2, each load being short-circuitable by a switch K1, K2 controlled by one of signals A1, A2, respectively. The two switches K1 and K2 are in series between terminal 1 and junction point 6 of load 12 and resistor R.

As compared with the assembly of FIG. 1, this assembly has the advantage of having a common regulation for the two loads. However, output voltage Vout must be higher to enable supply of the two loads at the same time, which imposes a larger switch M.

Another disadvantage of this assembly is that it generates a permanent consumption in resistor R and thus forbids a true shutdown function of the system.

Another disadvantage is that a power variation of the supplied loads is not possible independently from each other.

FIG. 3 shows a third conventional example of a power regulation circuit intended to supply several loads. In this example, each load 11, 12 is supplied by a capacitor C1, C2 which is specific thereto. Cathode 1 of diode D is connected to each of capacitors C1, C2 via a switch K1 or K2, respectively. Supply voltages Vout1 and Vout2 of loads Q1 and Q2 are respectively sampled across capacitors C1 and C2. Circuit 5′ for providing the control pulse train to cut off switch M receives two control signals FB1 and FB2 respectively sampled across resistors R1 and R2, each connecting loads 11 and 12 separately to ground.

The solution of FIG. 3 is close to a solution consisting of providing one full converter per load, which is not desirable for bulk reasons.

This assembly enables independent regulation of each of the load supply voltages. However, it requires two output capacitors of the regulator as well as two full output voltage regulation loops. Further, the controls of loads Q1 and Q2 generate a complex management of the power stored in inductance L.

Another disadvantage is that switches K1 and K2 must exhibit small on-state resistances to avoid generating any additional dissipation with respect to loads 11 and 12 with which they are in series.

### BRIEF SUMMARY OF THE INVENTION

One embodiment of the present invention provides a power converter of voltage step-up or step-down switched-mode power supply type which overcomes the disadvantages of known solutions.

One embodiment of the present invention enables independent regulation of the respective supply voltages of the loads without requiring several output capacitors.

One embodiment of the present invention also enables each of the loads to be able to stand a power variation function.

One embodiment of the present invention also provides an integrable solution compatible with the use of a circuit for generating pulse trains for controlling a cut-off switch comprising a single regulation reference input.

One embodiment of the present invention provides a power converter of switched-mode power supply type for providing a voltage to several loads independent from one another, comprising a circuit for generating strobe pulses of a D.C. supply voltage, and means for devoting to each load, within a period of relatively long duration as compared to the maximum duration of said strobe pulses and of relatively short duration as compared to the operating time of the load, at least one supply period during which said circuit regulates the voltage provided to the considered load.

According to an embodiment of the present invention, each load is connected in series with a switch between a first terminal of provision of the output voltage and a terminal connected to ground by a common current-to-voltage conversion element.

According to an embodiment of the present invention, the converter comprises a circuit for controlling said switches to assign to each of the loads its supply periods.

According to an embodiment of the present invention, a control signal for said strobe pulse generation circuit is sampled across the current-to-voltage conversion element.

According to an embodiment of the present invention, a current-limiting element is connected to the connection point of said switches and of the current-to-voltage conversion element, a control signal for said circuit for generating the strobe pulses being sampled at the respective junction points of each load with the corresponding switch, and synchronization switches being interposed between each of the sampling points and the corresponding input of said circuit for generating the strobe pulses.

According to an embodiment of the present invention, the duty cycles of the supply periods of two loads are inverted with respect to each other.

According to an embodiment of the present invention, the loads to be supplied are formed of light-emitting diodes in series.

The present invention also provides a method for sharing a power converter between several independent loads, by devoting to each of the loads periodic supply time windows during which the power converter is respectively dedicated thereto, the periodicity of the time windows being selected according to the remanence time of said loads.

The foregoing and other features, and advantages of the present invention will be discussed in detail in the following non-limiting description of specific embodiments in connection with the accompanying drawings.

### BRIEF DESCRIPTION OF THE SEVERAL VIEWS OF THE DRAWINGS

FIGS. 1 to 3, previously described, are intended to show the state of the art and the problem to solve;

FIG. 4 very schematically shows in the form of blocks an embodiment of a power converter according to the present invention;

FIGS. 5A, 5B, 5C, and 5D illustrate the operation of the converter of FIG. 4;

FIG. 6 shows a simplified embodiment of a selection element of the converter of FIG. 4;

FIGS. 7A, 7B, and 7C illustrate, in the form of timing diagrams, the operation of the element of FIG. 6;

FIG. 8 shows a detailed embodiment of a control circuit of the power converter of FIG. 4; and

FIGS. 9A, 9B, 9C, 9D, and 9E illustrate, in the form of timing diagrams, the operation of the converter of FIG. 8.

### DETAILED DESCRIPTION OF THE INVENTION

Same elements have been designated with same reference numerals in the different drawings and the timing diagrams of FIGS. 5, 7, and 9 have been drawn out of scale. For clarity, only those elements which are useful to the understanding of the present invention have been shown in the drawings and will be described hereafter. In particular, the details constitutive of the control pulse train generation circuits of the cut-off switches of the shown converters have not been detailed and are no object of the present invention, the present invention being compatible with the use of any conventional pulse train generation circuit.

The present invention will be described in relation with an example of application to step-up converters. However, it more generally applies to any converter, be it a voltage step-up or step-down converter, the assembly of the inductive element of the switch and of the diode, although different according to the converter type, having no influence upon the operation of the present invention.

A feature of one embodiment of the present invention is to devote to each of the loads periodic supply time windows, different from one load to another.

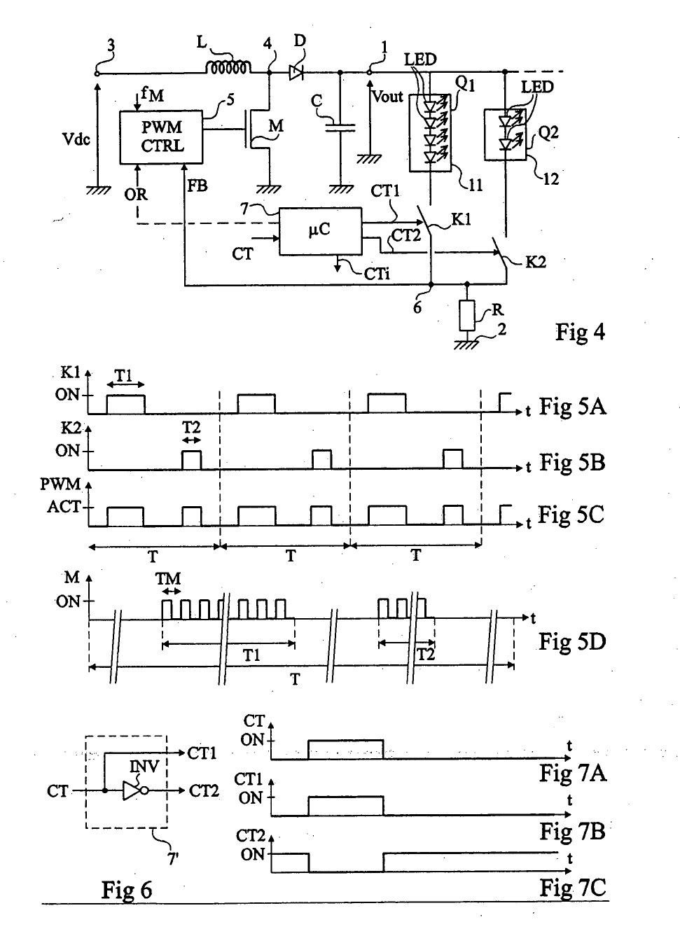

FIG. 4 very schematically shows in the form of blocks an embodiment of a power converter for supplying two loads 11 and 12 according to the present invention.

In this example, loads 11 and 12 are series associations of light-emitting diodes forming, for example, the backlighting elements of a screen. For example, load 11 (Q1) comprises four light-emitting diodes LED in series while load 12 (Q2) only has two.

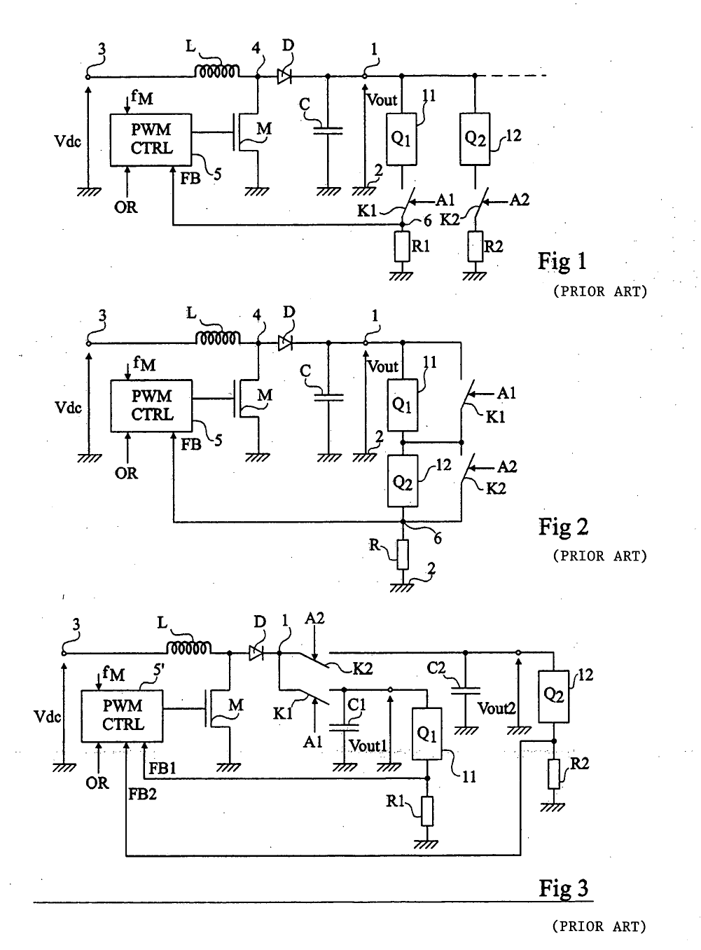

The actual power conversion circuit uses many of the same components as the conventional circuit of FIGS. 1 or 2. Thus, a cut-off switch M is connected to junction point 4 of an inductive element L with a diode D between a terminal 3 of application of a D.C. input voltage Vdc and a terminal 1 connected to ground 2 by a capacitor C for providing an output supply voltage Vout. A circuit 5 for providing control pulses of cut-off switch M is similar to the conventional circuit described in relation with FIGS. 1 and 2. Circuit 5 comprises an input for receiving a reference signal OR of the value of the desired output voltage, an input for receiving a regulation signal FB and an input for receiving a clock signal f_{M} of relatively high frequency (generally, several hundreds of kilohertz).

Each load 11 or 12 is connected in series with a switch K1 or K2, respectively, between terminal 1 and a first terminal 6 of a current-to-voltage conversion resistor R having its other terminal connected to ground 2. Feedback signal FB is sampled from terminal 6.

Each switch is controlled by a signal CT1 or CT2, respectively, provided by a circuit 7 (μC), for example, a microcontroller. Circuit 7 receives, for example, one or several reference signals CT setting the control needs of loads 11 and 12, and defines the time periods assigned to each load with a relatively low frequency as compared to the relatively high cut-off frequency of supply voltage Vdc.

FIGS. 5A, 5B, 5C, and 5D illustrate, in the form of timing diagrams, the operation of a power converter such as shown in FIG. 4. FIG. 5A illustrates the on periods (ON) of switch K1. FIG. 5B illustrates the on periods (ON) of switch K2. FIG. 5C illustrates the periods during which circuit 5 is active (ACT), that is, provides a control pulse train to switch M to regulate output voltage Vout. FIG. 5D illustrates an example of a turn-on pulse train (ON) of switch M.

The present invention takes advantage from the fact that the loads that the converter must supply (especially light-emitting diodes) have a proper operation, even if they do not permanently receive a voltage. In particular, for diodes, their lighting has a sufficient remanence to enable periods when their supply is stopped. To achieve this, account is taken of this remanence of the diodes (or more generally of the periods during which the load, for example, a motor, can temporarily receive no supply) to set the repetition frequency (period T, FIG. 5C) of periods T1, respectively, T2, of supply of each of the loads. For the system to properly operate, another condition is that the frequency (1/T) of the respective supply periods of the different loads is smaller than control frequency f_{M} of the cut-off switch. This condition is illustrated by FIG. 5D which shows that period T_{M} of the pulses provided by circuit 5 is very low as compared to repetition period T of the control sequences of loads 11 and 12.

Repetition period T of periods T1 and T2 assigned to loads 11 and 12 is short as compared to the average on time of the loads (at least a few seconds in the case of backlighting diodes) and long as compared to the duration (the longest in the case of an FWM frequency modulation) of the strobe pulses. For example, period T is at least 100 times greater than the duration of the strobe pulses and at least 10 times smaller than the average on time of the loads.

An advantage of the converter of FIG. 4 is that it enables an independent regulation on each of the branches supplied by the converter.

Another advantage resulting therefrom is that the loads can thus be regulated in power variation independently from each other. It is enough to synchronize reference OR with periods T1 and T2. This power variation is, for example, directly conditioned by signal OR provided to circuit 5 and made variable by microcontroller 7 according to a power reference value that it receives for the considered load.

Another advantage, more specifically as compared to the diagram of FIG. 2, is that it avoids a permanent consumption in the circuit and thus enables true shutdown of the converter and of the supplied loads.

Another advantage is that it preserves the use of a single power converter whatever the number of loads to be supplied. In particular, as illustrated in FIG. 4, microcontroller 7 may provide one or several additional control signals CTi to other loads. The only condition is that all loads be likely to be periodically supplied with a frequency which is compatible with their “remanence” and which is smaller than the switched-mode power supply frequency.

Preferably, the respective load supply periods (periods T1 and T2) do not overlap. Accordingly, at most, the duty cycle of the two control signals CT1 and CT2 of switches K1 and K2 is inverted.

A resulting advantage is that the converter of FIG. 4 enables optimizing the size of cut-off switch M since the maximum output voltage corresponds to the voltage required by the greatest load.

FIG. 6 illustrates a simplified embodiment of a circuit 7′ for providing signals CT1 and CT2 in the case where the periods assigned to the two loads 11 and 12 are complementary (for example, 60% and 40%, 20% and 80%, etc.). In this case, circuit 7′ comprises a simple inverter INV receiving a control signal CT as an input, and provides two outputs respectively with the reproduced input signal CT (signal CT1) and this signal CT inverted (signal CT2).

FIGS. 7A, 7B, and 7C illustrate in timing diagrams the operation of control circuit 7′. They show an example of control signal CT (FIG. 7A), signal CT1 (FIG. 7B), and signal CT2 (FIG. 7C).

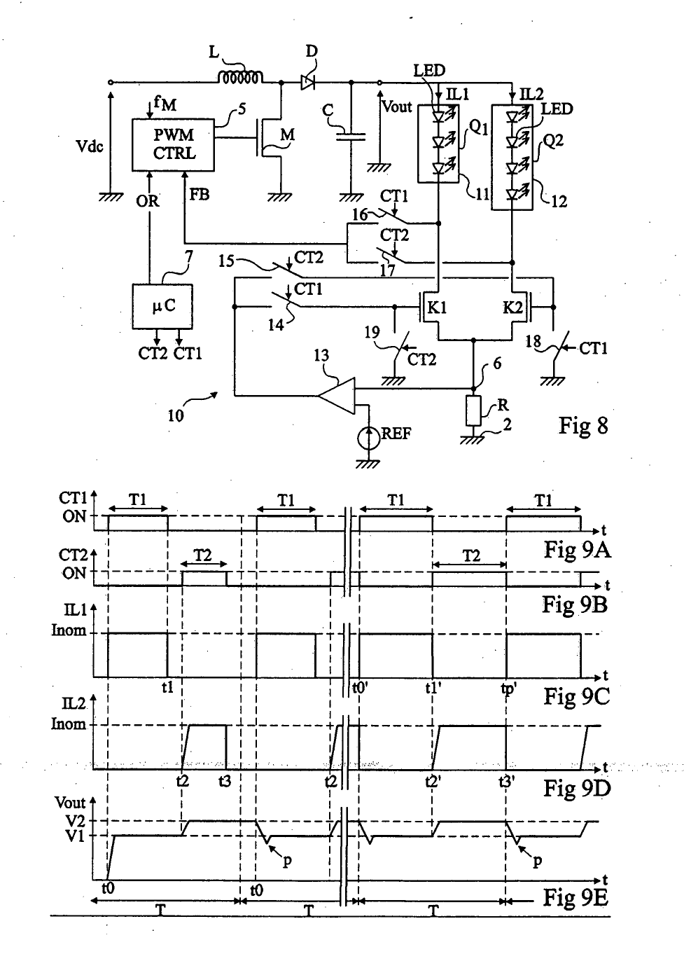

FIG. 8 shows an embodiment of a circuit 10 for synchronizing switches K1 and K2 according to an optional embodiment of the present invention. It shows all the elements described in relation with FIG. 4, except the number of light-emitting diodes LED of the loads (load 11 here comprises three light-emitting diodes LED while load 12 comprises 4).

In this example, switches K1 and K2 are formed of MOS transistors.

The function of circuit 10 is to operate transistors K1 and K2 in linear mode during the supply transition from one load to the other. To achieve this, a current-limiting element 13 receives a reference REF on a first terminal while its second terminal is connected to node 6 of connection of switches K1 and K2 to resistor R. The output of current-limiting element 13 is connected to the respective gates of switches K1 and K2 via switches 14 and 15 respectively controlled by signals CT1 and CT2.

According to this embodiment, signal FB is sampled upstream of switches K1 and K2. Accordingly, two switches 16 and 17 respectively connect the interconnection nodes of loads 11 and 12 with their switches K1 and K2 to the input terminal of signal FB of circuit 5. Their switches 16 and 17 are respectively controlled by signals CT1 and CT2. Finally, two switches 18 and 19 connect the respective gates of MOS transistors K1 and K2 to ground 2. Switch 18 associated with transistor K2 is controlled by signal CT1 while switch 19 associated with transistor K1 is controlled by signal CT2.

FIGS. 9A, 9B, 9C, 9D, and 9E illustrate in timing diagrams the operation of the circuit of FIG. 8. FIG. 9A illustrates the on periods (ON) of switches 14, 16, and 18 controlled by signal CT1. FIG. 9B illustrates the on periods (ON) of switches 15, 17, and 19 controlled by signal CT2. FIG. 9C illustrates the shape of current IL1 in load 11. FIG. 9D illustrates the shape of current IL2 in load 12. FIG. 9E illustrates the shape of voltage Vout.

It is assumed that at a time t0, the power converter is activated and microcontroller 7 sets a first period T1 of conduction of the first load 11. Switches 14, 16, and 18 are on while switches 15, 17, and 19 are off. Starting from a discharge state, voltage Vout increases from zero to reach a voltage level V1 corresponding to the reference value provided by microcontroller 7. Current IL1 in the load increases at the same time, to reach a nominal current Inom adapted to light-emitting diodes LED. At the end of period T1, switches 14, 16, and 18 are turned off (time t1). It is assumed in the left-hand portion of the timing diagrams of FIG. 9 that the duty cycles are not inverted. Accordingly, time t2 of beginning of the supply of load 12 and of turning-on of switches 15, 17, and 19 is delayed with respect to time t1. Load 12 comprises more light-emitting diodes than the first one, voltage Vout must, for a same current Inom, be higher (level V2) than on supply of load 11. In the case of a power variation conditioned by reference value OR on circuit 5, levels V1 and V2 are accordingly adapted. On the side of current IL2, the presence of current-limiting element 13 avoids a peak linked to the turning-on of the different switches.

It is assumed that at a time t3, period T2 of supply of the second load stops. Level Vout remains at level V2 until the next time to of starting of the first load. At this time, level Vout falls to level V1 while current IL1 increases in the first load. In the vicinity of level V1, a slight drop in level Vout (point p) due to the regulation can be observed.

In the right-hand portion of the timing diagrams of FIGS. 9, a duty cycle of 50% is assumed for each of loads 11 and 12. Times t1′ (end of periods T1) and t2′ (start of periods T2) are confounded, and times t0′ (start of periods T1) and t3′ (end of periods T2) are confounded due to the 50% duty cycle. As in the previous case, current limiter 13 avoids current peaks at times t2′.

Of course, the present invention is likely to have various, alterations, improvements, and modifications which will readily occur to those skilled in the art. In particular, although the present invention has been described in relation with a voltage step-up converter, it also applies with no modification of the controls to a voltage step-down converter. The only difference lies in the actual conversion stage, which remains conventional.

Further, the generation of the control signals adapted to the operation of the power converter and of the controlled loads is within the abilities of those skilled in the art based on the functional indications given hereabove and by using conventional tools.

Moreover, more than two loads can be controlled independently from one another.

Finally, within a same period T, a different number of periods from one load to another may be provided instead of one period, respectively, T1 or T2 for each load. For example, a unity duration of supply of all the loads is set as a quotient of period T and a unity number of durations is assigned to each load according to the power desired for this load.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A switched-mode power supply power converter for providing a voltage to plural loads independent from one another, comprising:
a strobe pulse generation circuit for generating strobe pulses of a D.C. supply voltage; and
means for devoting to each load, within a period of relatively long duration as compared to a maximum duration of said strobe pulses and of relatively short duration as compared to an operating time of the load, at least one supply period during which said circuit regulates the voltage provided to the load.

2. The converter of claim 1, wherein the means include plural switches, wherein each load is connected in series with a respective one of the switches between a first terminal of provision of the output voltage and a terminal connected to ground by a common current-to-voltage conversion element.

3. The converter of claim 2, wherein the means include a circuit for controlling said switches to assign to each of the loads its supply periods.

4. The power converter of claim 2, wherein a control signal for said strobe pulse generation circuit is sampled across the current-to-voltage conversion element.

5. The converter of claim 2, wherein a current-limiting element is connected to the connection point of said switches and of the current-to-voltage conversion element, a control signal for said circuit for generating the strobe pulses being sampled at the respective junction points of each load with the corresponding switch, and synchronization switches being interposed between each of the sampling points and the corresponding input of said circuit for generating the strobe pulses.

6. The converter of claim 1, wherein the supply periods of two loads have respective duty cycles that are inverted with respect to each other.

7. The power converter of claim 1, wherein the loads to be supplied are formed of light-emitting diodes in series.

8. A method for sharing a power converter between independent first and second loads having respective remanence times, the method comprising:
devoting to the first load a periodic first supply time window during which the power converter is dedicated to the first load; and
devoting to the second load a periodic second supply time window during which the power converter is dedicated to the second load, the supply time windows having respective periods that are set according to the respective remanence times of said loads.

9. The method of claim 8, wherein the step of devoting to the first load includes controlling a first switch connected between the first load and the power converter and the step of devoting to the second load includes controlling a second switch connected between the second load and the power converter.

10. The method of claim 9, wherein the step of controlling the first switch includes controlling the first switch based on a feedback signal taken at a node coupled to both of the switches and the step of controlling the second switch includes controlling the second switch based on the feedback signal.

11. The method of claim 8, wherein the supply time windows of the first and second loads have respective duty cycles that are inverted with respect to each other.

12. A switched-mode power conversion circuit, comprising:
first and second loads independent from one another;
a switched-mode power converter structured to voltage pulses of a supply voltage to the loads;
a first control switch connected between the power circuit and the first load;
a second control switch connected between the power circuit and the second load; and
a control circuit connected to the control switches and structured to control the first control switch with a first control signal having a period that is intermediate a maximum duration of the voltage pulses and a remanence time of the first load, and structured to control the second control switch with a second control signal having a period that is intermediate the maximum duration of the voltage pulses and a remanence time of the second load.

13. The power conversion circuit of claim 12, further comprising a current-to-voltage conversion element connected between a voltage reference node of the power converter and a first intermediate node connected to both control switches.

14. The power conversion circuit of claim 13, wherein the power converter includes a strobe pulse generation circuit having an input connected to the first intermediate node.

15. The power conversion circuit of claim 13, further comprising:
a current-limiting element having an input connected to the first intermediate node and an output;
a first synchronization switch connected between the output of the current-limiting element and a control terminal of the first control switch, the first synchronization switch being coupled to the control circuit and controlled by the first control signal; and
a second synchronization switch connected between the output of the current-limiting element and a control terminal of the second control switch, the second synchronization switch being coupled to the control circuit and controlled by the second control signal.

16. The power conversion circuit of claim 15, further comprising:
a third synchronization switch connected between the voltage reference node and the control terminal of the first control switch, the third synchronization switch being coupled to the control circuit and controlled by the second control signal; and
a fourth synchronization switch connected between the voltage reference node and the control terminal of the second control switch, the fourth synchronization switch being coupled to the control circuit and controlled by the first control signal.

17. The power conversion circuit of claim 16, wherein the power converter includes a strobe pulse generation circuit having an input, the power conversion circuit further comprising:
a fifth synchronization switch connected between the input of the strobe pulse generation circuit and a second intermediate node between the first load and the first control switch, the fifth synchronization switch being coupled to the control circuit and controlled by the first control signal; and
a sixth synchronization switch connected between the input of the strobe pulse generation circuit and a third intermediate node between the second load and the second control switch, the sixth synchronization switch being coupled to the control circuit and controlled by the second control signal.

18. The power conversion circuit of claim 12, wherein each of the loads is formed of light-emitting diodes in series.
